(19) United States
(12) Patent Application Publication
(10) Pub. No.: US 2025/0175972 A1
(43) Pub. Date: May 29, 2025

(54) SYSTEMS, METHODS, AND DEVICES FOR MAC LAYER INTER-UE COORDINATION (IUC)

(71) Applicant: Apple Inc., Cupertino, CA (US)

(72) Inventors: Haijing Hu, Los Gatos, CA (US); Zhibin Wu, Los Altos, CA (US); Naveen Kumar R. Palle Venkata, San Diego, CA (US); Chunxuan Ye, San Diego, CA (US); Yuqin Chen, Beijing (CN); Fangli Xu, Beijing (CN); Pavan Nuggehalli, San Carlos, CA (US); Ralf Rossbach, San Jose, CA (US); Alexander Sirotkin, Munich (DE)

(21) Appl. No.: 18/836,927

(22) PCT Filed: Feb. 13, 2022
(86) PCT No.: PCT/CN2022/076125

§ 371 Date: Aug. 8, 2024

(51) Int. Cl. H04W 72/121; H04W 72/231; H04W 72/40; H04W 72/543

(52) U.S. Cl. CPC H04W 72/121; H04W 72/231; H04W 72/40; H04W 72/543

(57) ABSTRACT

Techniques, described herein, include solutions for enabling inter-user equipment (UE) coordination (IUC) using media access control (MAC) control elements (CE). A first UE may send an IUC request to a second UE, and the second UE may respond with a MAC CE that includes IUC information. The IUC information may indicated one or more wireless resources that the first UE may use to communicate with the second UE. The IUC information may also include a time-domain validity for wireless resources, which may include one or more durations of time the wireless resources may be used for communication. The first UE may also implement a latency bound during which the second UE is to respond with the IUC information. In some implementations, discontinuous reception (DRX) may be used by the first and second UEs, and DRX active times of the UEs may be modified or configured to facilitate IUC.

### FIELD

This disclosure relates to wireless communication networks including techniques for enabling communications between devices.

### BACKGROUND

As the number of mobile devices within wireless networks, and the demand for mobile data traffic, continue to increase, changes are made to system requirements and architectures to better address current and anticipated demands. For example, some wireless communication networks may be developed to implement fifth generation (5G) or new radio (NR) technology, sixth generation (6G) technology, and so on. An aspect of such technology includes addressing how wireless devices communicate with one another, which may involve direct communication between user equipment (UE) devices.

### BRIEF DESCRIPTION OF THE DRAWINGS

The present disclosure will be readily understood and enabled by the detailed description and accompanying figures of the drawings. Like reference numerals may designate like features and structural elements. Figures and corresponding descriptions are provided as non-limiting examples of aspects, implementations, etc., of the present disclosure, and references to “an” or “one” aspect, implementation, etc., may not necessarily refer to the same aspect, implementation, etc., and may mean at least one, one or more, etc.

FIG. 1 is a diagram of an example process of media access control (MAC) layer inter-UE (user equipment) coordination (IUC).

FIG. 2 is a diagram of examples of network resource availability and IUC messaging.

FIG. 3 is a diagram of an example of discontinuous reception (DRX) and IUC messaging.

FIG. 4 is a diagram of an example of a network according to one or more implementations described herein.

FIGS. 5-7 are diagrams of examples of time-domain validity according to one or more implementations described herein.

FIGS. 8-10 are diagrams of examples of IUC messaging using different periodicities according to one or more implementations described herein.

FIGS. 11-12 are diagrams of examples of a latency bound for IUC messaging according to one or more implementations described herein.

FIGS. 13-14 are diagrams of examples of IUC messaging and interactions involving DRX according to one or more implementations described herein.

FIG. 15 is another example diagram of IUC messaging and interactions involving DRX according to one or more implementations described herein.

FIG. 16 is a diagram of an example of components of a device according to one or more implementations described herein.

FIG. 17 is a diagram of example interfaces of baseband circuitry according to one or more implementations described herein.

FIG. 18 is a block diagram of an example control plane protocol stack according to one or more implementations described herein.

FIG. 19 is a block diagram illustrating components, according to one or more implementations described herein, able to read instructions from a machine-readable or computer-readable medium (e.g., a non-transitory machine-readable storage medium) and perform any one or more of the methodologies discussed herein.

### DETAILED DESCRIPTION

The following detailed description refers to the accompanying drawings. Like reference numbers in different drawings may identify the same or similar features, elements, operations, etc. Additionally, the present disclosure is not limited to the following description as other implementations may be utilized, and structural or logical changes made, without departing from the scope of the present disclosure.

Telecommunication networks may include user equipment (UEs) capable of communicating with base stations and other network nodes. In some implementations, UEs may also be capable of communicating directly with other UEs, which may be referred to as device-to-device (D2D) communication. This may include detecting nearby UEs, synchronizing with other UEs, establishing connections with other UEs, and using those connections to send and receive information. Depending on the scenario, UEs may be capable of performing one or more of these functions with, or without, the assistance or involvement of a base station, wireless router, or another type of network node.

To communicate with one another, UEs may perform one or more operations at the media access control (MAC) layer. An example of such an operation may include UEs sending and receiving MAC control elements (CEs) to ensure that messages and signaling between the UEs, including processes for transmitting (Tx) and receiving (Rx) such messages, are properly coordinated with respect to time, frequency, periodicity, etc. This may be generally referred to as inter-UE coordination (IUC). As described herein, IUC may also include the coordination of processes executed by UEs in support, or combination, with transmitting and receiving messages and signaling.

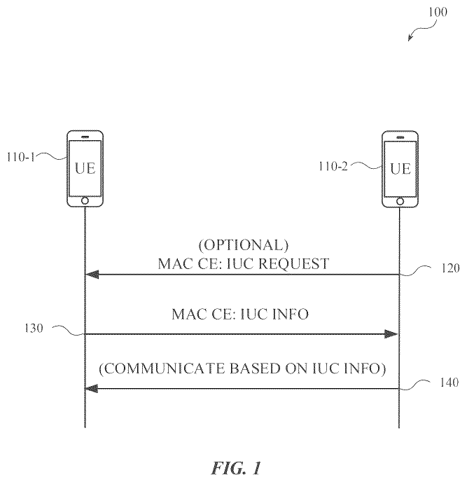

FIG. 1 is a diagram of an example process 100 of media access control (MAC) layer inter-UE (user equipment) coordination (IUC). As shown, process 100 may include UE 110-1 and UE 110-2. In some implementations, UE 110-2 may send a MAC CE that includes a request (e.g., an IUC request) to UE 110-1 (at 120). The request may be for information indicating which wireless resources (e.g., times, frequencies, periodicities, etc.) that UE 110-2 may later use to communicate with UE 110-1. In response, UE 110-1 may send a MAC CE to UE 110-2, which may include the requested information (e.g., IUC information) (130). UE 110-2 may use the information received to continue communicating with UE 110-1 (at 140). While UE 110-1 may send the IUC information to UE 110-2 in response to a request, in some implementations, UE 110-1 receiving such a request may be optional, such that UE 110-1 may also, or alternatively be configured to send the IUC information without having received an explicit request to do so.

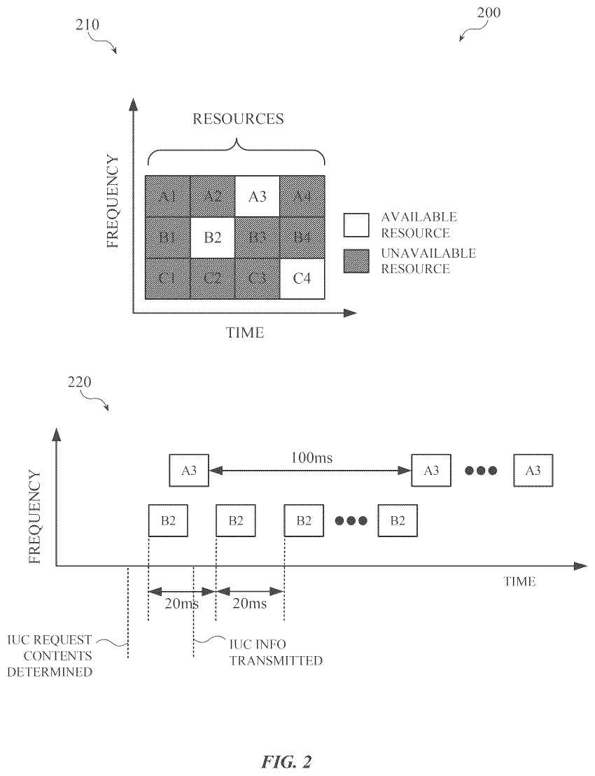

FIG. 2 is a diagram of examples 210 and 220 of network resource availability and IUC messaging. Example 210 includes a table with time represented along a horizontal axis and frequency represented along a vertical axis. The table also includes example resources A1, A2, A3, A4, B1, B2, . . . and so on. Each resource is indicated as being available or available. In such a scenario, the IUC information sent by UE 110-1 to UE 110-2 may include a subset of resources for inter-UE coordination. For example, the IUC information may include a subset of available resources (e.g., A3, B2, and C4) or a subset of unavailable resources (e.g., A1, A2, A4, B1, B3, B4, C1, C2, and C3).

Providing such information may enable UE 110-2 to communicate with UE 110-1 using wireless resources preferred or selected by UE 110-1, thereby facilitating or enabling coordination between the devices. For purposes of explaining FIG. 2, assume that UE 110-1 receives a MAC CE IUC request, selects resources B2 and A3 for communicating with UE 110-2, and transmits the IUC INFO to UE 110-2. B2 may include a periodicity of 20 milliseconds (ms) and A3 may have a periodicity of 100 ms. UE 110-2 may then use resources B2 and A3 to communicate with one another thereafter. When a resource reservation interval (or periodicity) is not used in resource selection, then the resource selected is for one-time use. When resource reservation interval is considered, then the resource is good for repetitive usage with reservation interval. So, when UE 110-2 receives an indication, from UE 110-1, of preferred resource(s) corresponding to a certain interval (e.g., 20 ms, 100 ms, etc.), the resource is to be periodic.

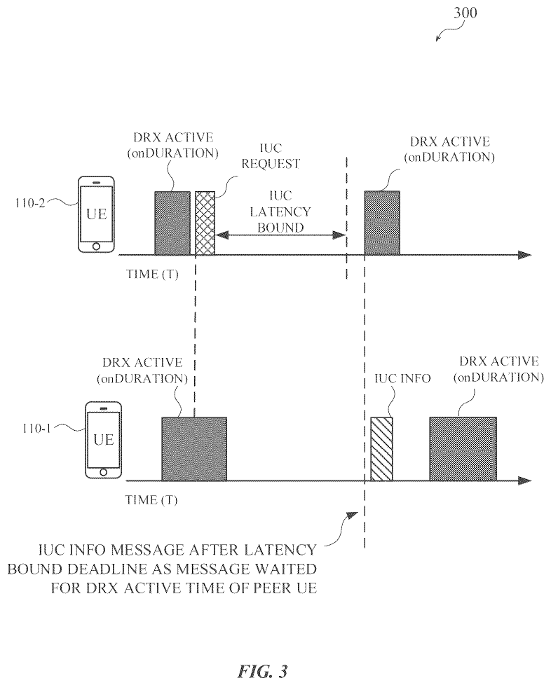

Currently available IUC techniques, however, fail to provide a way to define or convey a time-domain for the resources indicated in the IUC information. This may be referred to herein as a validity period or a validity window and may include a duration of time during which resources selected by a UE for IUC may be used. Currently available IUC techniques also fail to provide for the way IUC organization for different reservation periodicities are to be organized. An additional problem with currently available IUC techniques is described below with reference to FIG. 3.

FIG. 3 is a diagram of an example of discontinuous reception (DRX) and IUC messaging. As shown, in some implementations, UEs may implement DRX communication via a sidelink (SL) interface between the UEs. This may include unidirectional communication, whereby a Tx UE determines a transmission time based on a RX UE's DRC active state (e.g., onDuration). As such, when UE 110-2 communicates an IUC request to UE 110-1, the request may be sent in accordance with an onDuration of UE 110-1 in accordance with DRC. However, the IUC request may have a time or latency bound during which the IUC information may be received, which may not coincide with the onDuration of UE 110-2. If UE 110-1 sends the IUC information in accordance with the next DRX onDuration of UE 110-1, the IUC information may be sent too late (e.g., after the latency bound associated with the IUC request) and therefore may be invalid. As such, currently available IUC techniques fail to adequately resolve potential conflicts between IUC communications and DRX procedures.

Techniques, described herein, include solutions for enabling IUC using MAC CEs. For example, a first UE may send an IUC request to a second UE, and the second UE may respond with a MAC CE that includes IUC information. The IUC information may indicated one or more wireless resources that the first UE may use to communicate with the second UE. The IUC information may also include a time-domain validity for the wireless resources, which may include an indication for a single or one-time use of the wireless resources, a period during which the wireless resources may be used, or multiple periods or windows during which the wireless resources may be used.

In some implementations, the first UE may send multiple IUC requests to the second UE, and the second UE may respond to the requests collectively using a single MAC CE that includes multiple IUC information messages, a single MAC packet data unit (PDU) or a single transport block (TB) with multiple MAC CEs, or one MAC CE and IUC information message per request. The first UE may also implement a latency bound during which the second UE is to respond with the IUC information the latency bound may be configured based on signal latency and/or a processing gap, relative to a resource availability (e.g., a resource selection window), to ensure the IUC information message arrives at the first UE within time. In some implementations, discontinuous reception (DRX) may be used by the first and second UEs, and DRX active times (e.g., times of onDuration for the UEs) are configured and/or extended to ensure that the bounded IUC requests and IUC information messages are sent and received in accordance with the DRX active times of each UE.

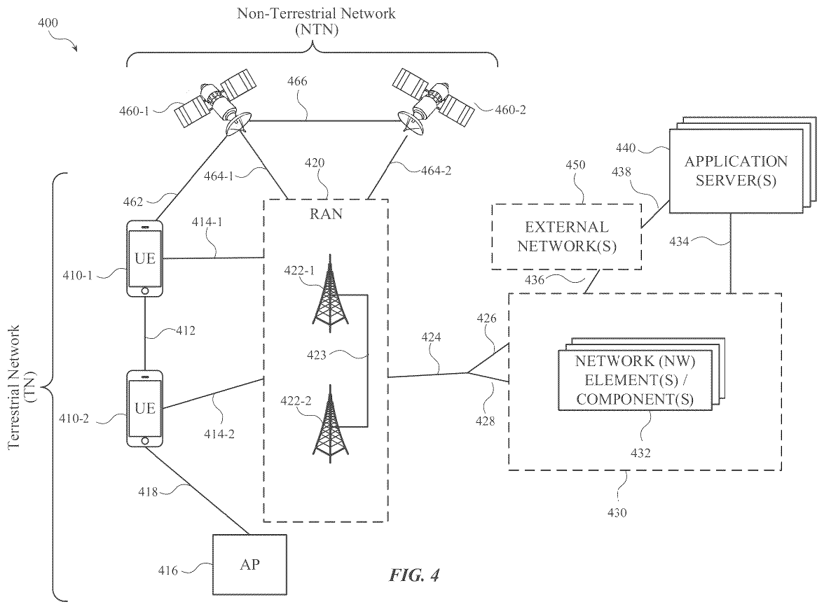

FIG. 4 is an example network 400 according to one or more implementations described herein. Example network 400 may include UEs 410-1, 410-2, etc. (referred to collectively as “UEs 410” and individually as “UE 410”), a radio access network (RAN) 420, a core network (CN) 430, application servers 440, external networks 450, and satellites 460-1, 460-2, etc. (referred to collectively as “satellites 460” and individually as “satellite 460”). As shown, network 400 may include a non-terrestrial network (NTN) comprising one or more satellites 460 (e.g., of a global navigation satellite system (GNSS)) in communication with UEs 410 and RAN 420.

The systems and devices of example network 400 may operate in accordance with one or more communication standards, such as 2nd generation (2G), 3rd generation (3G), 4th generation (4G) (e.g., long-term evolution (LTE)), and/or 5th generation (5G) (e.g., new radio (NR)) communication standards of the 3rd generation partnership project (3GPP). Additionally, or alternatively, one or more of the systems and devices of example network 400 may operate in accordance with other communication standards and protocols discussed herein, including future versions or generations of 3GPP standards (e.g., sixth generation (6G) standards, seventh generation (7G) standards, etc.), institute of electrical and electronics engineers (IEEE) standards (e.g., wireless metropolitan area network (WMAN), worldwide interoperability for microwave access (WiMAX), etc.), and more.

As shown, UEs 410 may include smartphones (e.g., handheld touchscreen mobile computing devices connectable to one or more wireless communication networks). Additionally, or alternatively, UEs 410 may include other types of mobile or non-mobile computing devices capable of wireless communications, such as personal data assistants (PDAs), pagers, laptop computers, desktop computers, wireless handsets, etc. In some implementations, UEs 410 may include internet of things (IoT) devices (or IoT UEs) that may comprise a network access layer designed for low-power IoT applications utilizing short-lived UE connections. Additionally, or alternatively, an IoT UE may utilize one or more types of technologies, such as machine-to-machine (M2M) communications or machine-type communications (MTC) (e.g., to exchanging data with an MTC server or other device via a public land mobile network (PLMN)), proximity-based service (ProSe) or device-to-device (D2D) communications, sensor networks, IoT networks, and more. Depending on the scenario, an M2M or MTC exchange of data may be a machine-initiated exchange, and an IoT network may include interconnecting IoT UEs (which may include uniquely identifiable embedded computing devices within an Internet infrastructure) with short-lived connections. In some scenarios, IoT UEs may execute background applications (e.g., keep-alive messages, status updates, etc.) to facilitate the connections of the IoT network.

UEs 410 may communicate and establish a connection with one or more other UEs 410 via one or more wireless channels 412, each of which may comprise a physical communications interface/layer. The connection may include an M2M connection, MTC connection, D2D connection, etc. In some implementations, UEs 410 may be configured to discover one another, negotiate wireless resources between one another, and establish connections between one another, without intervention or communications involving RAN node 422 or another type of network node. In some implementations, discovery, authentication, resource negotiation, registration, etc., may involve communications with RAN node 422 or another type of network node.

UEs 410 may communicate and establish a connection with (e.g., be communicatively coupled) with RAN 420, which may involve one or more wireless channels 414-1 and 414-2, each of which may comprise a physical communications interface/layer. In some implementations, a UE may be configured with dual connectivity (DC) as a multi-radio access technology (multi-RAT) or multi-radio dual connectivity (MR-DC), where a multiple receive and transmit (Rx/Tx) capable UE may use resources provided by different network nodes (e.g., 422-1 and 422-2) that may be connected via non-ideal backhaul (e.g., where one network node provides NR access and the other network node provides either E-UTRA for LTE or NR access for 5G). In such a scenario, one network node may operate as a master node (MN) and the other as the secondary node (SN). The MN and SN may be connected via a network interface, and at least the MN may be connected to the CN 430. Additionally, at least one of the MN or the SN may be operated with shared spectrum channel access, and functions specified for UE 410 can be used for an integrated access and backhaul mobile termination (IAB-MT). Similar for UE 401, the IAB-MT may access the network using either one network node or using two different nodes with enhanced dual connectivity (EN-DC) architectures, new radio dual connectivity (NR-DC) architectures, or the like. In some implementations, a base station (as described herein) may be an example of network node 422.

As shown, UE 410 may also, or alternatively, connect to access point (AP) 416 via connection interface 418, which may include an air interface enabling UE 410 to communicatively couple with AP 416. AP 416 may comprise a wireless local area network (WLAN), WLAN node, WLAN termination point, etc. The connection 4207 may comprise a local wireless connection, such as a connection consistent with any IEEE 702.11 protocol, and AP 416 may comprise a wireless fidelity (Wi-Fi®) router or other AP. While not explicitly depicted in FIG. 4, AP 416 may be connected to another network (e.g., the Internet) without connecting to RAN 420 or CN 430. In some scenarios, UE 410, RAN 420, and AP 416 may be configured to utilize LTE-WLAN aggregation (LWA) techniques or LTE WLAN radio level integration with IPsec tunnel (LWIP) techniques. LWA may involve UE 410 in RRC_CONNECTED being configured by RAN 420 to utilize radio resources of LTE and WLAN. LWIP may involve UE 410 using WLAN radio resources (e.g., connection interface 418) via IPsec protocol tunneling to authenticate and encrypt packets (e.g., Internet Protocol (IP) packets) communicated via connection interface 418. IPsec tunneling may include encapsulating the entirety of original IP packets and adding a new packet header, thereby protecting the original header of the IP packets.

RAN 420 may include one or more RAN nodes 422-1 and 422-2 (referred to collectively as RAN nodes 422, and individually as RAN node 422) that enable channels 414-1 and 414-2 to be established between UEs 410 and RAN 420. RAN nodes 422 may include network access points configured to provide radio baseband functions for data and/or voice connectivity between users and the network based on one or more of the communication technologies described herein (e.g., 2G, 3G, 4G, 5G, WiFi, etc.). As examples therefore, a RAN node may be an E-UTRAN Node B (e.g., an enhanced Node B, cNodeB, cNB, 4G base station, etc.), a next generation base station (e.g., a 5G base station, NR base station, next generation cNBs (gNB), etc.). RAN nodes 422 may include a roadside unit (RSU), a transmission reception point (TRxP or TRP), and one or more other types of ground stations (e.g., terrestrial access points). In some scenarios, RAN node 422 may be a dedicated physical device, such as a macrocell base station, and/or a low power (LP) base station for providing femtocells, picocells or the like having smaller coverage areas, smaller user capacity, or higher bandwidth compared to macrocells. As described below, in some implementations, satellites 460 may operate as bases stations (e.g., RAN nodes 422) with respect to UEs 410. As such, references herein to a base station, RAN node 422, etc., may involve implementations where the base station, RAN node 422, etc., is a terrestrial network node and also to implementation where the base station, RAN node 422, etc., is a non-terrestrial network node (e.g., satellite 460).

Some or all of RAN nodes 422, or portions thereof, may be implemented as one or more software entities running on server computers as part of a virtual network, which may be referred to as a centralized RAN (CRAN) and/or a virtual baseband unit pool (vBBUP). In these implementations, the CRAN or vBBUP may implement a RAN function split, such as a packet data convergence protocol (PDCP) split wherein radio resource control (RRC) and PDCP layers may be operated by the CRAN/vBBUP and other Layer 2 (L2) protocol entities may be operated by individual RAN nodes 422; a media access control (MAC)/physical (PHY) layer split wherein RRC, PDCP, radio link control (RLC), and MAC layers may be operated by the CRAN/vBBUP and the PHY layer may be operated by individual RAN nodes 422; or a “lower PHY” split wherein RRC, PDCP, RLC, MAC layers and upper portions of the PHY layer may be operated by the CRAN/vBBUP and lower portions of the PHY layer may be operated by individual RAN nodes 422. This virtualized framework may allow freed-up processor cores of RAN nodes 422 to perform or execute other virtualized applications.

In some implementations, an individual RAN node 422 may represent individual gNB-distributed units (DUs) connected to a gNB-control unit (CU) via individual F1 or other interfaces. In such implementations, the gNB-DUs may include one or more remote radio heads or radio frequency (RF) front end modules (RFEMs), and the gNB-CU may be operated by a server (not shown) located in RAN 420 or by a server pool (e.g., a group of servers configured to share resources) in a similar manner as the CRAN/vBBUP. Additionally, or alternatively, one or more of RAN nodes 422 may be next generation eNBs (i.e., gNBs) that may provide evolved universal terrestrial radio access (E-UTRA) user plane and control plane protocol terminations toward UEs 410, and that may be connected to a 5G core network (5GC) 430 via an NG interface.

Any of the RAN nodes 422 may terminate an air interface protocol and may be the first point of contact for UEs 410. In some implementations, any of the RAN nodes 422 may fulfill various logical functions for the RAN 420 including, but not limited to, radio network controller (RNC) functions such as radio bearer management, uplink and downlink dynamic radio resource management and data packet scheduling, and mobility management. UEs 410 may be configured to communicate using orthogonal frequency-division multiplexing (OFDM) communication signals with each other or with any of the RAN nodes 422 over a multicarrier communication channel in accordance with various communication techniques, such as, but not limited to, an OFDMA communication technique (e.g., for downlink communications) or a single carrier frequency-division multiple access (SC-FDMA) communication technique (e.g., for uplink and ProSe or sidelink (SL) communications), although the scope of such implementations may not be limited in this regard. The OFDM signals may comprise a plurality of orthogonal subcarriers.

In some implementations, a downlink resource grid may be used for downlink transmissions from any of the RAN nodes 422 to UEs 410, and uplink transmissions may utilize similar techniques. The grid may be a time-frequency grid (e.g., a resource grid or time-frequency resource grid) that represents the physical resource for downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises resource blocks, which describe the mapping of certain physical channels to resource elements. Each resource block may comprise a collection of resource elements (REs); in the frequency domain, this may represent the smallest quantity of resources that currently may be allocated. There are several different physical downlink channels that are conveyed using such resource blocks.

Further, RAN nodes 422 may be configured to wirelessly communicate with UEs 410, and/or one another, over a licensed medium (also referred to as the “licensed spectrum” and/or the “licensed band”), an unlicensed shared medium (also referred to as the “unlicensed spectrum” and/or the “unlicensed band”), or combination thereof. In an example, a licensed spectrum may include channels that operate in the frequency range of approximately 400 MHz to approximately 3.8 GHz, whereas the unlicensed spectrum may include the 5 GHz band. A licensed spectrum may correspond to channels or frequency bands selected, reserved, regulated, etc., for certain types of wireless activity (e.g., wireless telecommunication network activity), whereas an unlicensed spectrum may correspond to one or more frequency bands that are not restricted for certain types of wireless activity. Whether a particular frequency band corresponds to a licensed medium or an unlicensed medium may depend on one or more factors, such as frequency allocations determined by a public-sector organization (e.g., a government agency, regulatory body, etc.) or frequency allocations determined by a private-sector organization involved in developing wireless communication standards and protocols, etc.

To operate in the unlicensed spectrum, UEs 410 and the RAN nodes 422 may operate using licensed assisted access (LAA), cLAA, and/or feLAA mechanisms. In these implementations, UEs 410 and the RAN nodes 422 may perform one or more known medium-sensing operations or carrier-sensing operations in order to determine whether one or more channels in the unlicensed spectrum is unavailable or otherwise occupied prior to transmitting in the unlicensed spectrum. The medium/carrier sensing operations may be performed according to a listen-before-talk (LBT) protocol.

The LAA mechanisms may be built upon carrier aggregation (CA) technologies of LTE-Advanced systems. In CA, each aggregated carrier is referred to as a component carrier (CC). In some cases, individual CCs may have a different bandwidth than other CCs. In time division duplex (TDD) systems, the number of CCs as well as the bandwidths of each CC may be the same for DL and UL. CA also comprises individual serving cells to provide individual CCs. The coverage of the serving cells may differ, for example, because CCs on different frequency bands will experience different pathloss. A primary service cell or PCell may provide a primary component carrier (PCC) for both UL and DL and may handle RRC and non-access stratum (NAS) related activities. The other serving cells are referred to as SCells, and each SCell may provide an individual secondary component carrier (SCC) for both UL and DL. The SCCs may be added and removed as required, while changing the PCC may require UE 410 to undergo a handover. In LAA, cLAA, and fcLAA, some or all of the SCells may operate in the unlicensed spectrum (referred to as “LAA SCells”), and the LAA SCells are assisted by a PCell operating in the licensed spectrum. When a UE is configured with more than one LAA SCell, the UE may receive UL grants on the configured LAA SCells indicating different PUSCH starting positions within a same subframe. To operate in the unlicensed spectrum, UEs 410 and the RAN nodes 422 may also operate using stand-alone unlicensed operation where the UE may be configured with a PCell, in addition to any SCells, in unlicensed spectrum.

The PDSCH may carry user data and higher layer signaling to UEs 410. The physical downlink control channel (PDCCH) may carry information about the transport format and resource allocations related to the PDSCH channel, among other things. The PDCCH may also inform UEs 410 about the transport format, resource allocation, and hybrid automatic repeat request (HARQ) information related to the uplink shared channel. Typically, downlink scheduling (e.g., assigning control and shared channel resource blocks to UE 410-2 within a cell) may be performed at any of the RAN nodes 422 based on channel quality information fed back from any of UEs 410. The downlink resource assignment information may be sent on the PDCCH used for (e.g., assigned to) each of UEs 410.

The PDCCH uses control channel elements (CCEs) to convey the control information, wherein a number of CCEs (e.g., 6 or the like) may consists of a resource element groups (REGs), where a REG is defined as a physical resource block (PRB) in an OFDM symbol. Before being mapped to resource elements, the PDCCH complex-valued symbols may first be organized into quadruplets, which may then be permuted using a sub-block interleaver for rate matching, for example. Each PDCCH may be transmitted using one or more of these CCEs, where each CCE may correspond to nine sets of four physical resource elements known as REGs. Four quadrature phase shift keying (QPSK) symbols may be mapped to each REG. The PDCCH may be transmitted using one or more CCEs, depending on the size of the DCI and the channel condition. There may be four or more different PDCCH formats defined in LTE with different numbers of CCEs (e.g., aggregation level, L=1, 2, 4, 8, or 46).

Some implementations may use concepts for resource allocation for control channel information that are an extension of the above-described concepts. For example, some implementations may utilize an extended (E)-PDCCH that uses PDSCH resources for control information transmission. The EPDCCH may be transmitted using one or more ECCEs. Similar to the above, each ECCE may correspond to nine sets of four physical resource elements known as an EREGs. An ECCE may have other numbers of EREGs in some situations.

The RAN nodes 422 may be configured to communicate with one another via interface 423. In implementations where the system is an LTE system, interface 423 may be an X2 interface. In NR systems, interface 423 may be an Xn interface. The X2 interface may be defined between two or more RAN nodes 422 (e.g., two or more eNBs/gNBs or a combination thereof) that connect to evolved packet core (EPC) or CN 430, or between two eNBs connecting to an EPC. In some implementations, the X2 interface may include an X2 user plane interface (×2-U) and an X2 control plane interface (X2-C). The X2-U may provide flow control mechanisms for user data packets transferred over the X2 interface and may be used to communicate information about the delivery of user data between eNBs or gNBs. For example, the X2-U may provide specific sequence number information for user data transferred from a master eNB (MeNB) to a secondary cNB (SeNB); information about successful in sequence delivery of PDCP packet data units (PDUs) to a UE 410 from an SeNB for user data; information of PDCP PDUs that were not delivered to a UE 410; information about a current minimum desired buffer size at the ScNB for transmitting to the UE user data; and the like. The X2-C may provide intra-LTE access mobility functionality (e.g., including context transfers from source to target eNBs, user plane transport control, etc.), load management functionality, and inter-cell interference coordination functionality.

As shown, RAN 420 may be connected (e.g., communicatively coupled) to CN 430. CN 430 may comprise a plurality of network elements 432, which are configured to offer various data and telecommunications services to customers/subscribers (e.g., users of UEs 410) who are connected to the CN 430 via the RAN 420. In some implementations, CN 430 may include an evolved packet core (EPC), a 5G CN, and/or one or more additional or alternative types of CNs. The components of the CN 430 may be implemented in one physical node or separate physical nodes including components to read and execute instructions from a machine-readable or computer-readable medium (e.g., a non-transitory machine-readable storage medium). In some implementations, network function virtualization (NFV) may be utilized to virtualize any or all the above-described network node roles or functions via executable instructions stored in one or more computer-readable storage mediums (described in further detail below). A logical instantiation of the CN 430 may be referred to as a network slice, and a logical instantiation of a portion of the CN 430 may be referred to as a network sub-slice. Network Function Virtualization (NFV) architectures and infrastructures may be used to virtualize one or more network functions, alternatively performed by proprietary hardware, onto physical resources comprising a combination of industry-standard server hardware, storage hardware, or switches. In other words, NFV systems may be used to execute virtual or reconfigurable implementations of one or more EPC components/functions.

As shown, CN 430, application servers 440, and external networks 450 may be connected to one another via interfaces 434, 436, and 438, which may include IP network interfaces. Application servers 440 may include one or more server devices or network elements (e.g., virtual network functions (VNFs) offering applications that use IP bearer resources with CM 430 (e.g., universal mobile telecommunications system packet services (UMTS PS) domain, LTE PS data services, etc.). Application servers 440 may also, or alternatively, be configured to support one or more communication services (e.g., voice over IP (VOIP sessions, push-to-talk (PTT) sessions, group communication sessions, social networking services, etc.) for UEs 410 via the CN 430. Similarly, external networks 450 may include one or more of a variety of networks, including the Internet, thereby providing the mobile communication network and UEs 410 of the network access to a variety of additional services, information, interconnectivity, and other network features.

As shown, example network 400 may include an NTN that may comprise one or more satellites 460-1 and 460-2 (collectively, “satellites 460”). Satellites 460 may be in communication with UEs 410 via service link or wireless interface 462 and/or RAN 420 via feeder links or wireless interfaces 464 (depicted individually as 464-1 and 464). In some implementations, satellite 460 may operate as a passive or transparent network relay node regarding communications between UE 410 and the terrestrial network (e.g., RAN 420). In some implementations, satellite 460 may operate as an active or regenerative network node such that satellite 460 may operate as a base station to UEs 410 (e.g., as a gNB of RAN 420) regarding communications between UE 410 and RAN 420. In some implementations, satellites 460 may communicate with one another via a direct wireless interface (e.g., 466) or an indirect wireless interface (e.g., via RAN 420 using interfaces 464-1 and 464-2).

Additionally, or alternatively, satellite 460 may include a GEO satellite, LEO satellite, or another type of satellite. Satellite 460 may also, or alternatively pertain to one or more satellite systems or architectures, such as a global navigation satellite system (GNSS), global positioning system (GPS), global navigation satellite system (GLONASS), BeiDou navigation satellite system (BDS), etc. In some implementations, satellites 460 may operate as bases stations (e.g., RAN nodes 422) with respect to UEs 410. As such, references herein to a base station, RAN node 422, etc., may involve implementations where the base station, RAN node 422, etc., is a terrestrial network node and implementation, where the base station, RAN node 422, etc., is a non-terrestrial network node (e.g., satellite 460). As described herein, UE 410 and base station 422 may communicate with one another, via interface 414, to enable enhanced power saving techniques.

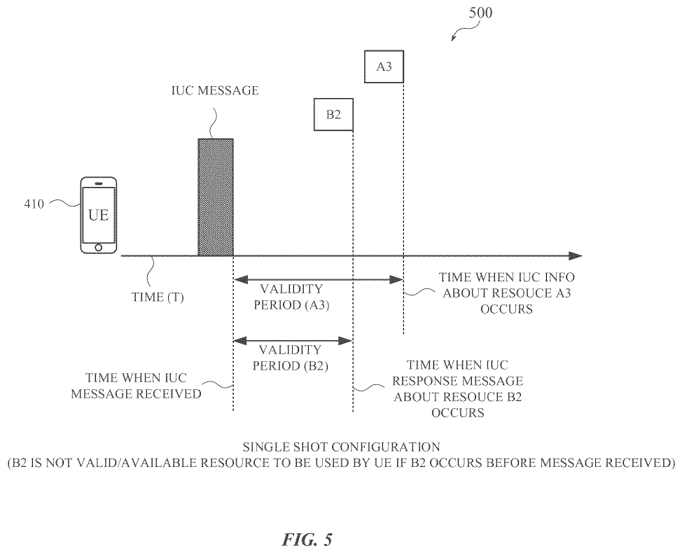

FIGS. 5-7 are diagrams of examples 500, 600, and 700 of time-domain validity according to one or more implementations described herein. FIG. 5 may include an example of a single-use validity window for one or more resources. UE 410 may be configured to communicate a MAC CE message with a IUC request or IUC information, and the resource(s) (e.g., A3, B2, etc.) indicated in the messages may not include a periodicity. This may indicate that the resources are selected as single-use, or one-time-use resources. For example, as shown in FIG. 5, a single use validity period for an A3 resource may extend from a time when an IUC message (e.g., an IUC request message or an IUC information message) is received until the end of the next A3 resource. Similarly, a single use validity period for a B2 resource may extend from a time when an IUC message (e.g., an IUC request message or an IUC information message) is received until the end of the next B2 resource.

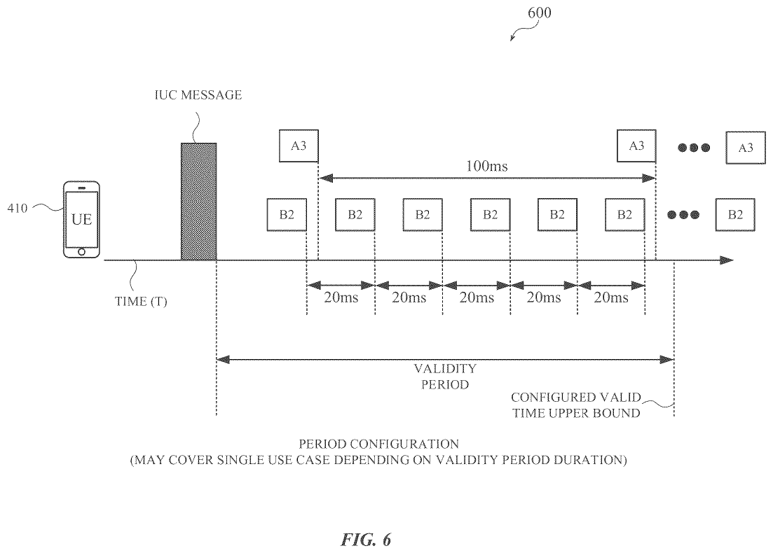

FIG. 6 may include an example of a validity period for one or more resources. UE 410 may be configured to communicate a MAC CE message with a IUC request or IUC information, and the resource(s) (e.g., A3, B2, etc.) indicated in the messages may include a validity period. A validity period may include a duration of time during which the resources may be used for IUC communications between UEs 410. The validity period may include a start time and an end time. Additionally, or alternatively, the validity period may begin upon reception of the IUC message and extend until an end time (e.g., an upper bound) indicated in the message. As shown in FIG. 6, an IUC message may indicate resources A3 and B2 and include a validity period include some A3 resources and multiple B2 resources, each having their own periodicity. In some implementations, when a validity time or period includes only one instance of resources (e.g., one instance of B2 and/or A3) the time or period may have a similar effect as a single-use validity period.

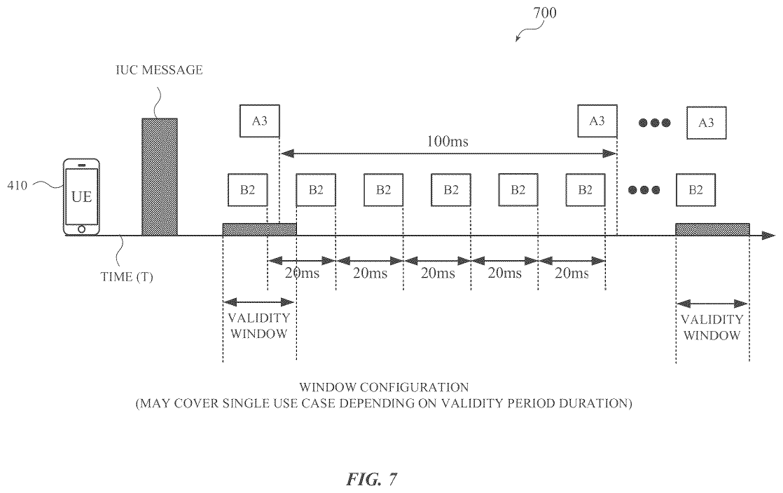

FIG. 7 may include an example of validity windows for one or more resources. UE 410 may be configured to communicate a MAC CE message with a IUC request or IUC information, and the resource(s) (e.g., A3, B2, etc.) indicated in the messages may include one or more validity windows. A validity window may include a duration of time during which resources may be used for IUC communications between UEs 410. A validity window may include a start time and an end time, and an IUC message may indicate multiple validity windows. As shown in FIG. 6, An IUC message may indicate resources A3 and B2, and may include two different validity windows that each involve resources A3 and B2. In some implementations, the IUC message may indicate each validity window in particular. In some implementations, the IUC message may indicate a validity window duration, a periodicity for the validity window, and a quantity of validity window interactions. In some implementations, the IUC message may indicate that validity windows are periodic or aperiodic. In some implementations, when a validity window includes only one instance of a resource (e.g., one instance of B2 and/or A3) the validity window may have a similar effect as a single-use validity window.

In some implementations, a validity time or window indicated in an IUC message may be different for different resources. In some implementations, an IUC request from a UE may include a desired or preferred validity time. In some implementations, a validity time or window may be configured in whole, or in part, by RRC messaging via a Uu interface (e.g., in an SIB or another pre-configuration message). When a validity time or window is explicitly given by an SL MAC CE or RRC message, UE 410 may filter its indicated resources with the known validity period when generating an IUC information message.

In some implementations, when no validity time is introduced or configured, an IUC information message may default to a single use scenario (e.g., discarded when the sending UE 410 uses the corresponding resource. In such a scenario, the IUC information message may provide a periodic sequence valid candidate resources (e.g., preferred resources) and the receiving UE 410 may use one or more of the candidate resources except for the “first” one as it is used as a single use resource. In some implementations, the IUC information message may be valid until a new IUC information is received from the same UE 410 regardless of the contents (e.g., whether the new contents conflict with the contents of a prior IUC information message). In some implementations, the IUC information message including resources and/or validity information, of a certain periodicity, may be valid until a new IUC information message with the same periodicity is received. In some implementations, information of an IUC information message may be valid until explicitly cancelled in another MAC-CE signal or message.

In some implementations, when two validity periods or windows overlap with one another, the most recently received validity periods or windows may be used on a per resource periodicity basis (e.g., for resources and instances where the overlapping occurs). In some implementations, when UE 410 is aware that a validity window received in a prior IUC information message is still valid, UE 410 may be prevented from using the validity window in another IUC information message unless specifically requested to do so in a IUC request message.

A validity time (e.g., validity period or window(s)) may be represented as a start time plus a validity period. In some implementations, the start time may be the first occurrence of a resource in a periodic sequence, such that resources with different time slots may expire at different times. In some implementations, the start time may be when the IUC information message is received regardless of the periodicity of an individual resource. In some implementations, a validity time may be explicitly indicated by a window (e.g., a start time and an end time) and only resources within the window(s) may be valid. In some implementations, the validity time may be represented as an integral value of “how many periods of the resource sequence may be extended. For example, each resource may be valid for 10 periods, such that if a period is 100 ms then the validity time may be 1 second,

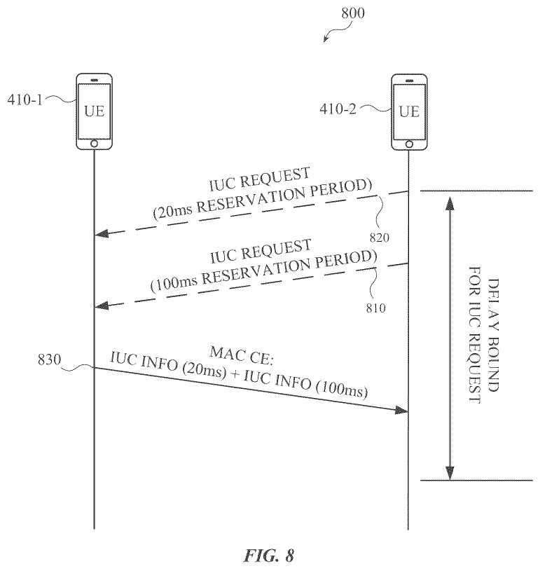

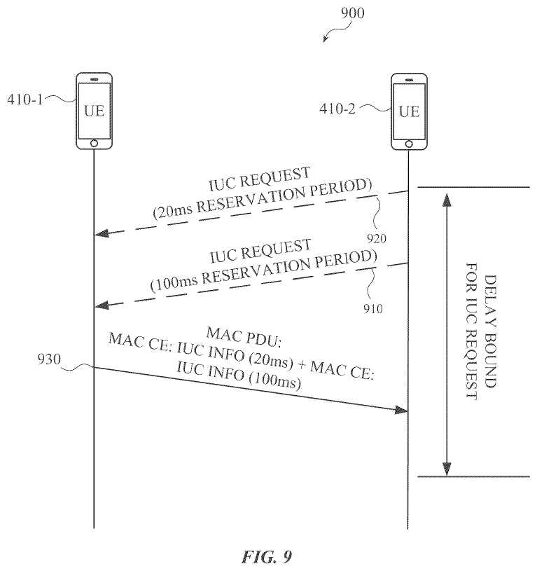

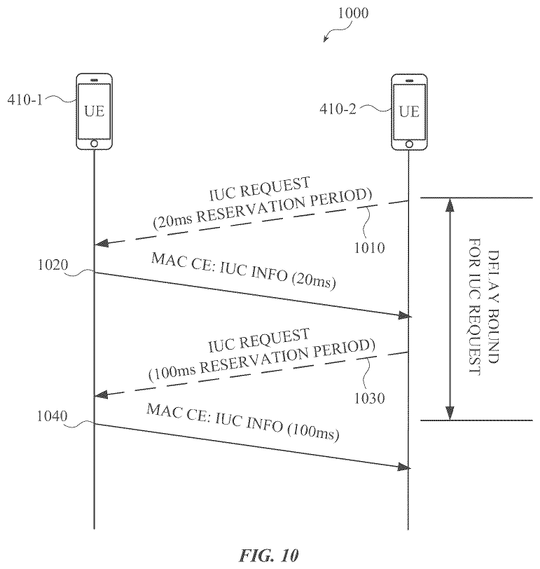

FIGS. 8-10 are diagrams of examples 800, 900, 1000 of IUC messaging using different periodicities according to one or more implementations described herein. As shown in FIG. 8, UE 410-2 may be configured to send multiple MAC CE IUC request messages of different periodicities to UE 410-1 (at 810 and 820), and UE 410-1 may multiplex the MAC CE IUC request messages into a single a MAC CE IUC information message (at 830). As shown in FIG. 9, UE 410-2 may be configured to send multiple MAC CE IUC request messages of different periodicities to UE 410-1 (at 920 and 930), and UE 410-1 may put IUC information of different periodicities in different MAC CEs but may multiplexed the MAC CEs in the same MAC packet data unit (PDU) transport block (TB) (at 930). As shown in FIG. 10, UE 410-2 may be configured to send MAC CE IUC request messages of different periodicities to UE 410-1 (at 1010 and 1030), and UE 410-1 may respond to each request individually using a MAC CE with IUC information of different periodicities (at 1020 and 1040). UE 410-2 may not be allowed to send another IUC request until response of first request received or IUC request time bound expires. Communications 810, 820, 910, 920, 1010, and 1030 are indicated in FIGS. 8-10 as being optional such that 410-1 may be configured to send communications 830, 930, 1020 and 1040 without having received a request from UE 410-2.

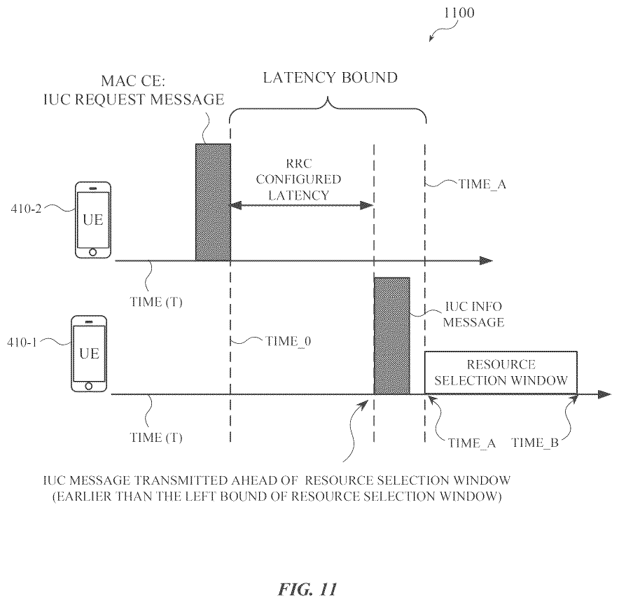

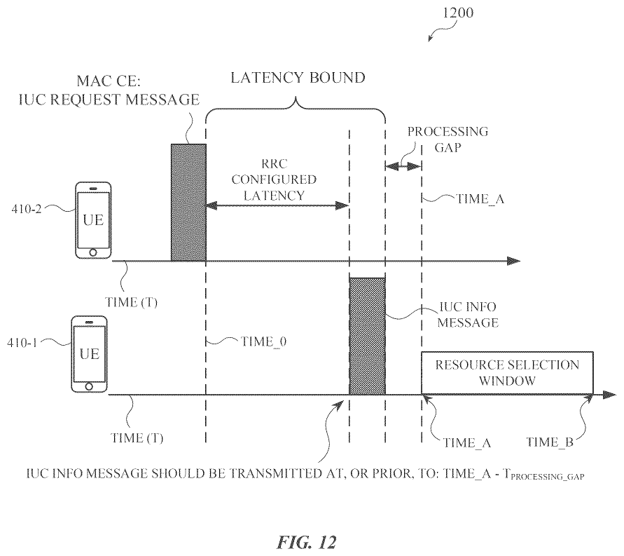

FIGS. 11-12 are diagrams of examples of a latency bound for IUC messaging according to one or more implementations described herein. FIG. 11 is a diagram of an example of a latency bound for IUC messages. As described herein, an IUC request message and an IUC response message (referred to herein at times as an “IUC information message”) may be bound or dependent on one another, such that for example, an IUC information message, responding to an IUC request message, is to be transmitted and received within a specified duration of time. IUC information messages received after that specified duration are invalid.

An IUC request message may include a resource selection window during which UE 410-2 may select resources, based on an IUC information message, for communicating with UE 410-1. As shown, the resource selection window may include a start time (Time_A) and an end time (Time_B). In some implementations, UE 410-2 and/or UE 410-1 may determine the latency bound, or a latency point endpoint, based on an earliest value (e.g., Time_A) of the resource selection window. In some implementations, the latency bound may be configured by RRC signaling. When a latency is already configured via RRC and a resource selection window is available, UE 410-2 and/or UE 410-1 may determine the latency bound, or a latency endpoint, based on a duration of the configured latency measured from Time_0 and/or a start time of the selection window, depending on which is earlier greater, and which is later In some implementations, UE 410-1 may be configured to choose the earlier value among Time_A and Time_0 as the latency bound so the UE may ensure the resource included in the IUC information message is to be received by UE 410-2 by the time the resource selection window begins. In some other implementations, UE 410-1 may be configured to choose the later value of Time_A and Time_0 as the latency bound because to enable UE 410-1 to have enough time to generate the accurate IUC information based on sufficient sensing history, which may involve waiting for the maximal allowed latency to send IUC information message.

FIG. 12 is a diagram of an example of a latency bound for IUC messages, which a includes processing gap. As described herein, an IUC request message and an IUC response message (referred to herein at times as an “IUC information message”) may be bound or dependent on one another, such that for example, an IUC information message, responding to an IUC request message, is to be transmitted and received within a specified duration of time. IUC information messages received after that specified duration are invalid.

A processing gap, as described herein, may include a duration required by requesting UE 410-2 to receive and process a IUC information message. In addition to one or more of the latency bound techniques described above, a latency bound may include a start time of the resource window (Time_A) minus the processing gap. This may help ensure that the requesting UE 410-2 is able to receive and process the IUC information message prior to the resource selection window.

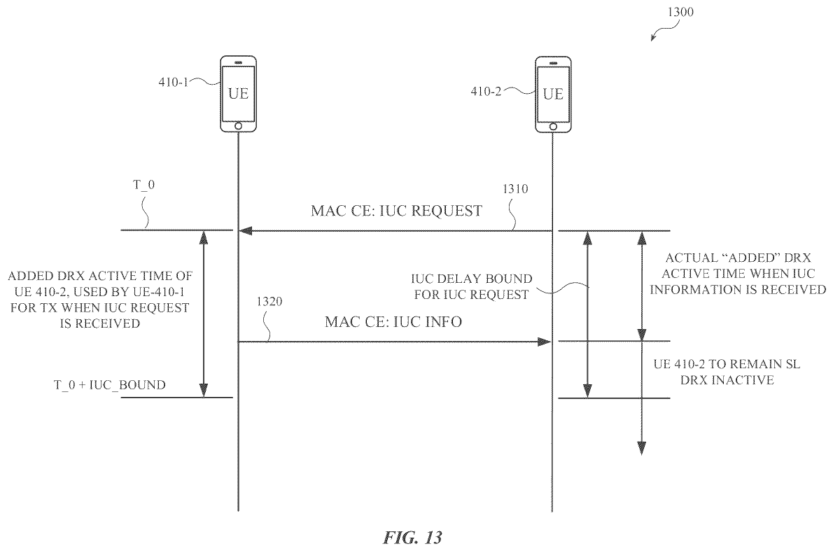

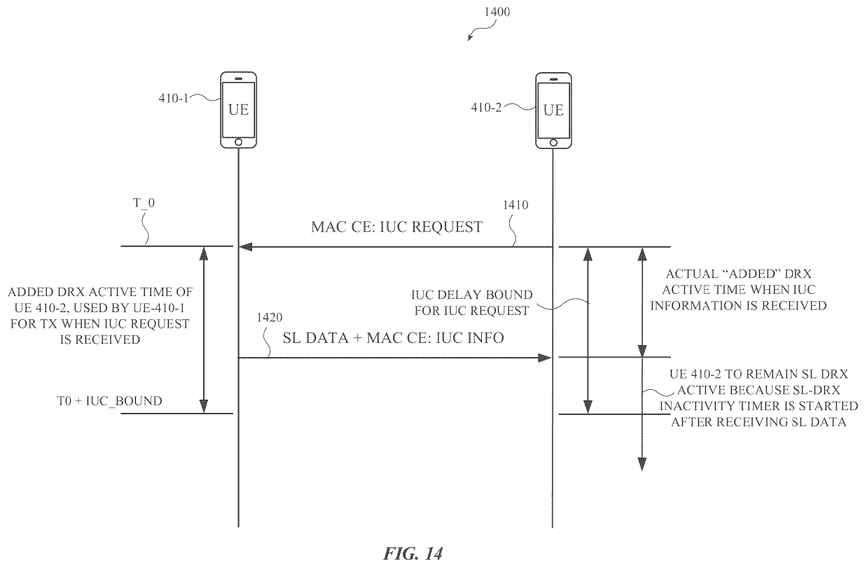

FIGS. 13-14 are diagrams of examples 1300 and 1400 of IUC messaging and interactions involving DRX according to one or more implementations described herein. As shown in FIG. 13, UE 410-2 may communicate a MAC CE IUC request to UE 410-1 (at 1310). For cases where SL DRX is used in UE 410-2 to send an IUC request to UE 410-1, reception of the IUC request may cause added active time to be implemented for UE 410-2. The added active time may be from the time of UE 410-1 receiving the IUC request (T_0) until expiration of an IUC bound (e.g., T_0+IUC_BOUND). As such, because UE 410-2 is assumed active during the IUC bound, UE 410-1 may send the MAC CE IUC information message (at 1320) within the IUC delay bound. Upon receiving the MAC CE IUC information, UE 410-2 may transition to DRX inactive for a remainder of the IUC delay bound.

Referring now to FIG. 14, UE 410-2 may UE 410-2 may communicate a MAC CE IUC request to UE 410-1 (at 1410). For cases where SL DRX is used in UE 410-2 to send an IUC request to UE 410-1, reception of the IUC request may cause added active time to be implemented by UE 410-2. The added active time may be from the time of UE 410-1 receiving the IUC request (T_0) until expiration of an IUC bound (e.g., T_0+IUC_BOUND). As such, because UE 410-2 is assumed active during the IUC bound, UE 410-1 may send the MAC CE IUC information message (at 1420) within the IUC delay bound. As shown in FIG. 14, the IUC information may be sent with SL DATA. Receiving the SL DATA may cause 410-2 to remain in an SL active state as the SL DATA may cause UE 410-2 to start an SL-DRX inactivity timer thereafter.

In scenarios where SL DRX is used in UE 410-2 for the voluntary transmission of IUC information to UE 410-2 (e.g., without a request from UE 410-2), UE 410-1 may do so when UE 410-2 is in a DRX active state (e.g., without an extended DRX active state described above with reference to FIGS. 13-14). Other factors, such as a channel busy ration (CBR) being high or link packet error rate (PER) being high may also determine if/when UE 410-1 uses a voluntary transmission to send IUC information. Additionally, or alternatively, when the IUC information does not indicate a periodicity, UE 410-1 may assume single-use or a one-time indicator of resources. Additionally, or alternatively, UE 410-1 may only indicate preferred resource slots which are within DRX active times (e.g., when an onDuration timer running) of UE 410-2.

In scenarios where SL DRX is used in UE 410-1 for transmissions from UE 410-2 to UE 410-2, UE 410-1 may only share resources (indicate preferred resources) that are within DRX active times (e.g., when an onDuration timer running) of UE 410-1. In such implementations, UE 410-1 may only consider its active times for peer UE 410-2 in an SL-DRX unicast configuration (e.g., for transmissions to UE 410-2 alone instead of to one or more other UEs). A unicast scenario may include a UE transmitting a message or signal to a specific UE as opposed to multiple UEs. Alternatively, when no preferred resource can be found within this DRX configuration, or the resource is not enough, UE 410-1 may include the resources that are within an active time of SL DRX configuration of UE 410-1 for other peer UEs and/or UE 410-1 for broadcast/groupcast traffic (e.g., resources that may be used to transmit to multiple UEs).

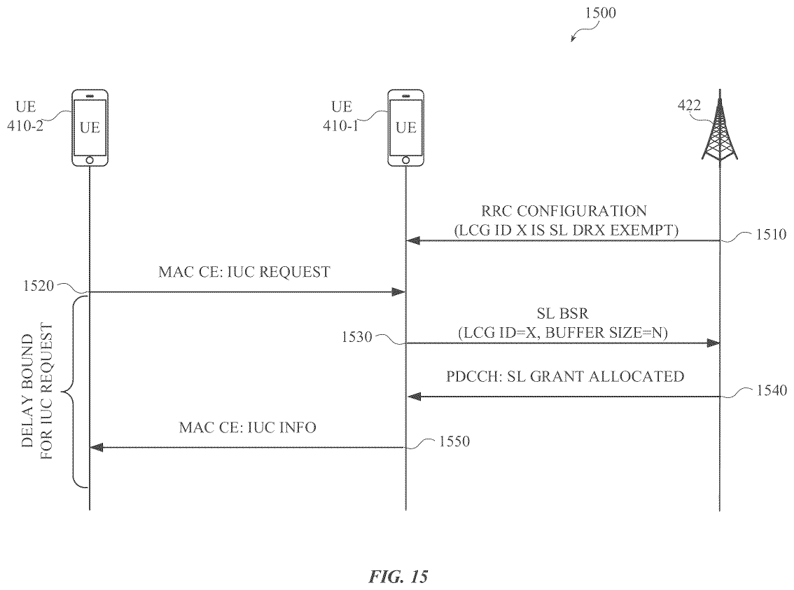

FIG. 15 is a diagram of an example 1500 of IUC messaging and interactions involving DRX according to one or more implementations described herein. To enable one or more techniques described herein, mode 1 UE 410-1 support to solicit SL grant from gNB may be considered. Mode 1 SL may include scenarios in which base station may allocate resources for SL communications. UE 410-1 may add extra DRX “active time” based on a time bound of an IUC request message for a DRX active time of UE 410-2, a serving base station 422 of UE 410-1 may not be aware of the change of the DRX active time of UE 410-2. As such, base station 422 may still allocate a “late” SL grant to match obsolete DRX active time of UE 410-2. Example 1500 includes a technique for addressing this issue and scenario, which includes an SL buffer status report (BSR) mechanism.

As shown, base station 422 may provide an RRC configuration to UE 410-1, indicating that a logical channel group (LCG) (e.g., LCG with an ID of “X”) is DRX exempt (at 1510). This may signify that the LCG may be used to override DRX mechanisms regarding mode 1 resource allocations of based station 422. UE 410-1 may receive a MAC CE IUC request from UE 410-2 (at 1520). UE 410-1 may send an SL BSR, indicating the LCG ID along with an appropriate buffer size (e.g., buffer size N) to base station 422 (at 1530). The buffer size may correspond to at least the amount of data to be transmitted in a sidelink associated with logical channel IDs used by the IUC MAC CE. In turn, base station 422 may respond with a mode 1 PDCCH: SL grant allocated message to UE 410-1 (at 1540). This may be done without consideration of the SL destination DRX configuration because the LCG ID has been designated for “DRX exempt”. The LCG ID may be configured to contain an SL logical channel (LCH) priority for SL MAC CEs. Additionally, or alternatively, with the SL grant having been received, UE 410-1 may proceed by providing a MAC CE IUC information message to UE 410-2 in accordance with the bound delay of the IUC request message (at 1550). In some implementations, the techniques described in FIG. 15 may be used for any mode 1 SL grant issue when base station 422 is not able to track a DRX active time of a SL destination, which may not be limited to IUC procedures.

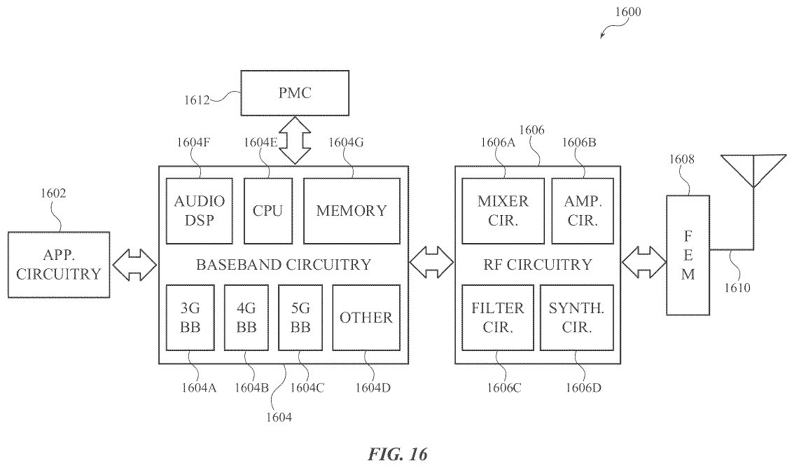

FIG. 16 is a diagram of an example of components of a device according to one or more implementations described herein. In some implementations, the device 1600 can include application circuitry 1602, baseband circuitry 1604, RF circuitry 1606, front-end module (FEM) circuitry 1608, one or more antennas 1610, and power management circuitry (PMC) 1612 coupled together at least as shown. The components of the illustrated device 1600 can be included in a UE or a RAN node. In some implementations, the device 1600 can include fewer elements (e.g., a RAN node may not utilize application circuitry 1602, and instead include a processor/controller to process IP data received from a CN such as 5GC 130 or an Evolved Packet Core (EPC)). In some implementations, the device 1600 can include additional elements such as, for example, memory/storage, display, camera, sensor (including one or more temperature sensors, such as a single temperature sensor, a plurality of temperature sensors at different locations in device 1600, etc.), or input/output (I/O) interface. In other implementations, the components described below can be included in more than one device (e.g., said circuitries can be separately included in more than one device for Cloud-RAN (C-RAN) implementations).

The application circuitry 1602 can include one or more application processors. For example, the application circuitry 1602 can include circuitry such as, but not limited to, one or more single-core or multi-core processors. The processor(s) can include any combination of general-purpose processors and dedicated processors (e.g., graphics processors, application processors, etc.). The processors can be coupled with or can include memory/storage and can be configured to execute instructions stored in the memory/storage to enable various applications or operating systems to run on the device 1600. In some implementations, processors of application circuitry 1602 can process IP data packets received from an EPC.

The baseband circuitry 1604 can include circuitry such as, but not limited to, one or more single-core or multi-core processors. The baseband circuitry 1604 can include one or more baseband processors or control logic to process baseband signals received from a receive signal path of the RF circuitry 1606 and to generate baseband signals for a transmit signal path of the RF circuitry 1606. Baseband circuitry 1604 can interface with the application circuitry 1602 for generation and processing of the baseband signals and for controlling operations of the RF circuitry 1606. For example, in some implementations, the baseband circuitry 1604 can include a 3G baseband processor 1604A, a 4G baseband processor 1604B, a 5G baseband processor 1604C, or other baseband processor(s) 1604D for other existing generations, generations in development or to be developed in the future (e.g., 2G, 6G, etc.). The baseband circuitry 1604 (e.g., one or more of baseband processors 1604A-D) can handle various radio control functions that enable communication with one or more radio networks via the RF circuitry 1606. In other implementations, some or all of the functionality of baseband processors 1604A-D can be included in modules stored in the memory 1604G and executed via a Central Processing Unit (CPU) 1604E. The radio control functions can include, but are not limited to, signal modulation/demodulation, encoding/decoding, radio frequency shifting, etc. In some implementations, modulation/demodulation circuitry of the baseband circuitry 1604 can include Fast-Fourier Transform (FFT), precoding, or constellation mapping/de-mapping functionality. In some implementations, encoding/decoding circuitry of the baseband circuitry 1604 can include convolution, tail-biting convolution, turbo, Viterbi, or Low-Density Parity Check (LDPC) encoder/decoder functionality. Implementations of modulation/demodulation and encoder/decoder functionality are not limited to these examples and can include other suitable functionality in other implementations.

In some implementations, the baseband circuitry 1604 can include one or more audio digital signal processor(s) (DSP) 1604F. The audio DSPs 1604F can include elements for compression/decompression and echo cancellation and can include other suitable processing elements in other implementations. Components of the baseband circuitry can be suitably combined in a single chip, a single chipset, or disposed on a same circuit board in some implementations. In some implementations, some or all of the constituent components of the baseband circuitry 1604 and the application circuitry 1602 can be implemented together such as, for example, on a system on a chip (SOC).

In some implementations, the baseband circuitry 1604 can provide for communication compatible with one or more radio technologies. For example, in some implementations, the baseband circuitry 1604 can support communication with a NG-RAN, an evolved universal terrestrial radio access network (EUTRAN) or other wireless metropolitan area networks (WMAN), a wireless local area network (WLAN), a wireless personal area network (WPAN), etc. Implementations in which the baseband circuitry 1604 is configured to support radio communications of more than one wireless protocol can be referred to as multi-mode baseband circuitry.

RF circuitry 1606 can enable communication with wireless networks using modulated electromagnetic radiation through a non-solid medium. In various implementations, the RF circuitry 1606 can include switches, filters, amplifiers, etc. to facilitate the communication with the wireless network. RF circuitry 1606 can include a receive signal path which can include circuitry to down-convert RF signals received from the FEM circuitry 1608 and provide baseband signals to the baseband circuitry 1604. RF circuitry 1606 can also include a transmit signal path which can include circuitry to up-convert baseband signals provided by the baseband circuitry 1604 and provide RF output signals to the FEM circuitry 1608 for transmission.

In some implementations, the receive signal path of the RF circuitry 1606 can include mixer circuitry 1606A, amplifier circuitry 1606B and filter circuitry 1606C. In some implementations, the transmit signal path of the RF circuitry 1606 can include filter circuitry 1606C and mixer circuitry 1606A. RF circuitry 1606 can also include synthesizer circuitry 1606D for synthesizing a frequency for use by the mixer circuitry 1606A of the receive signal path and the transmit signal path. In some implementations, the mixer circuitry 1606A of the receive signal path can be configured to down-convert RF signals received from the FEM circuitry 1608 based on the synthesized frequency provided by synthesizer circuitry 1606D. The amplifier circuitry 1606B can be configured to amplify the down-converted signals and the filter circuitry 1606C can be a low-pass filter (LPF) or band-pass filter (BPF) configured to remove unwanted signals from the down-converted signals to generate output baseband signals. Output baseband signals can be provided to the baseband circuitry 1604 for further processing. In some implementations, the output baseband signals can be zero-frequency baseband signals, although this is not a requirement. In some implementations, mixer circuitry 1606A of the receive signal path can comprise passive mixers, although the scope of the implementations is not limited in this respect.

In some implementations, the mixer circuitry 1606A of the transmit signal path can be configured to up-convert input baseband signals based on the synthesized frequency provided by the synthesizer circuitry 1606D to generate RF output signals for the FEM circuitry 1608. The baseband signals can be provided by the baseband circuitry 1604 and can be filtered by filter circuitry 1606C.

In some implementations, the mixer circuitry 1606A of the receive signal path and the mixer circuitry 1606A of the transmit signal path can include two or more mixers and can be arranged for quadrature down conversion and up conversion, respectively. In some implementations, the mixer circuitry 1606A of the receive signal path and the mixer circuitry 1606A of the transmit signal path can include two or more mixers and can be arranged for image rejection (e.g., Hartley image rejection). In some implementations, the mixer circuitry 1606A of the receive signal path and the mixer circuitry 2006A can be arranged for direct down conversion and direct up conversion, respectively. In some implementations, the mixer circuitry 1606A of the receive signal path and the mixer circuitry 1606A of the transmit signal path can be configured for super-heterodyne operation.

In some implementations, the output baseband signals and the input baseband signals can be analog baseband signals, although the scope of the implementations is not limited in this respect. In some alternate implementations, the output baseband signals and the input baseband signals can be digital baseband signals. In these alternate implementations, the RF circuitry 1606 can include analog-to-digital converter (ADC) and digital-to-analog converter (DAC) circuitry and the baseband circuitry 1604 can include a digital baseband interface to communicate with the RF circuitry 1606.

In some dual-mode implementations, a separate radio IC circuitry can be provided for processing signals for each spectrum, although the scope of the implementations is not limited in this respect.

In some implementations, the synthesizer circuitry 1606D can be a fractional-N synthesizer or a fractional N/N+1 synthesizer, although the scope of the implementations is not limited in this respect as other types of frequency synthesizers can be suitable. For example, synthesizer circuitry 1606D can be a delta-sigma synthesizer, a frequency multiplier, or a synthesizer comprising a phase-locked loop with a frequency divider.

The synthesizer circuitry 1606D can be configured to synthesize an output frequency for use by the mixer circuitry 1606A of the RF circuitry 1606 based on a frequency input and a divider control input. In some implementations, the synthesizer circuitry 1606D can be a fractional N/N+1 synthesizer.

In some implementations, frequency input can be provided by a voltage controlled oscillator (VCO), although that is not a requirement. Divider control input can be provided by either the baseband circuitry 1604 or the applications circuitry 1602 depending on the desired output frequency. In some implementations, a divider control input (e.g., N) can be determined from a look-up table based on a channel indicated by the applications circuitry 1602.

Synthesizer circuitry 1606D of the RF circuitry 1606 can include a divider, a delay-locked loop (DLL), a multiplexer and a phase accumulator. In some implementations, the divider can be a dual modulus divider (DMD) and the phase accumulator can be a digital phase accumulator (DPA). In some implementations, the DMD can be configured to divide the input signal by either N or N+1 (e.g., based on a carry out) to provide a fractional division ratio. In some example implementations, the DLL can include a set of cascaded, tunable, delay elements, a phase detector, a charge pump and a D-type flip-flop. In these implementations, the delay elements can be configured to break a VCO period up into Nd equal packets of phase, where Nd is the number of delay elements in the delay line. In this way, the DLL provides negative feedback to help ensure that the total delay through the delay line is one VCO cycle.

In some implementations, synthesizer circuitry 1606D can be configured to generate a carrier frequency as the output frequency, while in other implementations, the output frequency can be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some implementations, the output frequency can be a LO frequency (fLO). In some implementations, the RF circuitry 1606 can include an IQ/polar converter.

FEM circuitry 1608 can include a receive signal path which can include circuitry configured to operate on RF signals received from one or more antennas 1610, amplify the received signals and provide the amplified versions of the received signals to the RF circuitry 1606 for further processing. FEM circuitry 1608 can also include a transmit signal path which can include circuitry configured to amplify signals for transmission provided by the RF circuitry 1606 for transmission by one or more of the one or more antennas 1610. In various implementations, the amplification through the transmit or receive signal paths can be done solely in the RF circuitry 1606, solely in the FEM circuitry 1608, or in both the RF circuitry 1606 and the FEM circuitry 1608.

In some implementations, the FEM circuitry 1608 can include a TX/RX switch to switch between transmit mode and receive mode operation. The FEM circuitry can include a receive signal path and a transmit signal path. The receive signal path of the FEM circuitry can include an LNA to amplify received RF signals and provide the amplified received RF signals as an output (e.g., to the RF circuitry 1606). The transmit signal path of the FEM circuitry 1608 can include a power amplifier (PA) to amplify input RF signals (e.g., provided by RF circuitry 1606), and one or more filters to generate RF signals for subsequent transmission (e.g., by one or more of the one or more antennas 1610).

In some implementations, the PMC 1612 can manage power provided to the baseband circuitry 1604. In particular, the PMC 1612 can control power-source selection, voltage scaling, battery charging, or DC-to-DC conversion. The PMC 1612 can often be included when the device 1600 is capable of being powered by a battery, for example, when the device is included in a UE. The PMC 1612 can increase the power conversion efficiency while providing desirable implementation size and heat dissipation characteristics.

While FIG. 16 shows the PMC 1612 coupled only with the baseband circuitry 1604. However, in other implementations, the PMC 1612 may be additionally or alternatively coupled with, and perform similar power management operations for, other components such as, but not limited to, application circuitry 1602, RF circuitry 1606, or FEM circuitry 1608.

In some implementations, the PMC 1612 can control, or otherwise be part of, various power saving mechanisms of the device 1600. For example, if the device 1600 is in an RRC_Connected state, where it is still connected to the RAN node as it expects to receive traffic shortly, then it can enter a state known as Discontinuous Reception Mode (DRX) after a period of inactivity. During this state, the device 1600 can power down for brief intervals of time and thus save power.

If there is no data traffic activity for an extended period of time, then the device 1600 can transition off to an RRC_Idle state, where it disconnects from the network and does not perform operations such as channel quality feedback, handover, etc. The device 1600 goes into a very low power state and it performs paging where again it periodically wakes up to listen to the network and then powers down again. The device 1600 may not receive data in this state; in order to receive data, it can transition back to RRC_Connected state.

An additional power saving mode can allow a device to be unavailable to the network for periods longer than a paging interval (ranging from seconds to a few hours). During this time, the device is unreachable to the network and can power down completely. Any data sent during this time incurs a large delay and it is assumed the delay is acceptable.

Processors of the application circuitry 1602 and processors of the baseband circuitry 1604 can be used to execute elements of one or more instances of a protocol stack. For example, processors of the baseband circuitry 1604, alone or in combination, can be used execute Layer 3, Layer 2, or Layer 1 functionality, while processors of the baseband circuitry 1604 can utilize data (e.g., packet data) received from these layers and further execute Layer 4 functionality (e.g., transmission communication protocol (TCP) and user datagram protocol (UDP) layers). As referred to herein, Layer 3 can comprise a RRC layer, described in further detail below. As referred to herein, Layer 2 can comprise a medium access control (MAC) layer, a radio link control (RLC) layer, and a packet data convergence protocol (PDCP) layer, described in further detail below. As referred to herein, Layer 1 can comprise a physical (PHY) layer of a UE/RAN node, described in further detail below.

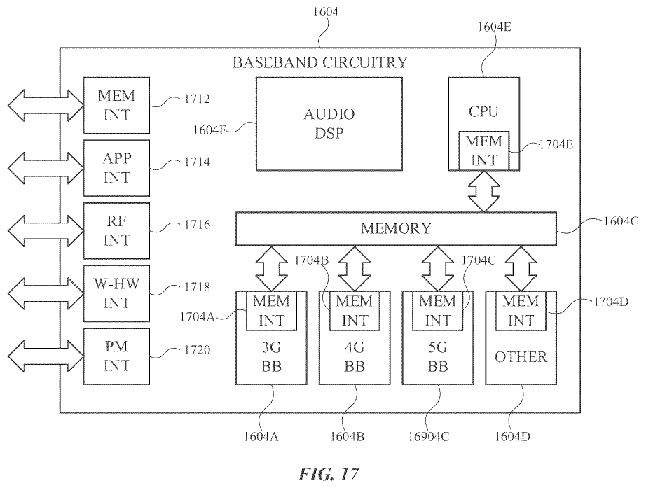

FIG. 17 is a diagram of example interfaces of baseband circuitry according to one or more implementations described herein. As discussed above, the baseband circuitry 1604 of FIG. 16 can comprise processors 1604A-E and a memory 1604G utilized by said processors. Each of the processors 1604A-E can include a memory interface, 1704A-E, respectively, to send/receive data to/from the memory 1604G.

The baseband circuitry 1604 can further include one or more interfaces to communicatively couple to other circuitries/devices, such as a memory interface 1712 (e.g., an interface to send/receive data to/from memory external to the baseband circuitry 1604), an application circuitry interface 1714 (e.g., an interface to send/receive data to/from the application circuitry 1602 of FIG. 16), an RF circuitry interface 1716 (e.g., an interface to send/receive data to/from RF circuitry 1606 of FIG. 16), a wireless hardware connectivity interface 1718 (e.g., an interface to send/receive data to/from Near Field Communication (NFC) components, Bluetooth® components (e.g., Bluetooth® Low Energy), Wi-Fi® components, and other communication components), and a power management interface 1720 (e.g., an interface to send/receive power or control signals to/from the PMC 1612).

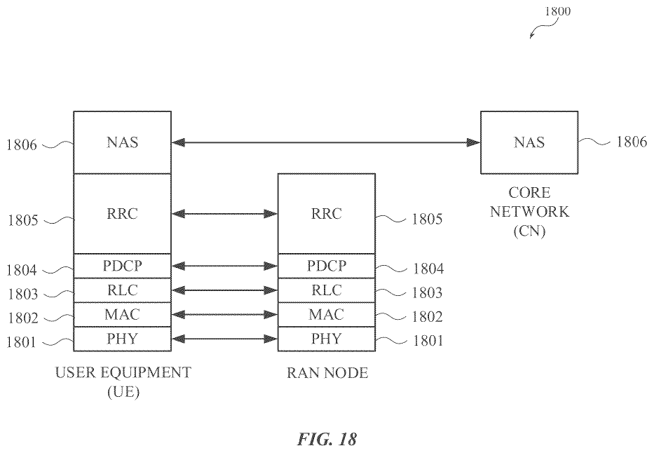

FIG. 18 is an illustration of a control plane protocol stack in accordance with some embodiments. In this embodiment, a control plane 1800 is shown as a communications protocol stack between network devices or entities.

The PHY layer 1801 may transmit or receive information used by the MAC layer 1802 over one or more air interfaces. The PHY layer 1801 may further perform link adaptation or adaptive modulation and coding (AMC), power control, cell search (e.g., for initial synchronization and handover purposes), and other measurements used by higher layers, such as the RRC layer 1805. The PHY layer 1801 may still further perform error detection on the transport channels, forward error correction (FEC) coding/decoding of the transport channels, modulation/demodulation of physical channels, interleaving, rate matching, mapping onto physical channels, and Multiple Input Multiple Output (MIMO) antenna processing.

The MAC layer 1802 may perform mapping between logical channels and transport channels, multiplexing of MAC service data units (SDUs) from one or more logical channels onto transport blocks (TB) to be delivered to PHY via transport channels, de-multiplexing MAC SDUs to one or more logical channels from transport blocks (TB) delivered from the PHY via transport channels, multiplexing MAC SDUs onto TBs, scheduling information reporting, error correction through hybrid automatic repeat request (HARQ), and logical channel prioritization.

The RLC layer 1803 may operate in a plurality of modes of operation, including: Transparent Mode (TM), Unacknowledged Mode (UM), and/or Acknowledged Mode (AM). The RLC layer 1803 may execute transfer of upper layer protocol data units (PDUs), error correction through automatic repeat request (ARQ) for AM data transfers, and concatenation, segmentation and reassembly of RLC SDUs for UM and AM data transfers. The RLC layer 1803 may also execute re-segmentation of RLC data PDUs for AM data transfers, reorder RLC data PDUs for UM and AM data transfers, detect duplicate data for UM and AM data transfers, discard RLC SDUs for UM and AM data transfers, detect protocol errors for AM data transfers, and perform RLC re-establishment.

The PDCP layer 1804 may execute header compression and decompression of IP data, maintain PDCP Sequence Numbers (SNs), perform in-sequence delivery of upper layer PDUs at re-establishment of lower layers, eliminate duplicates of lower layer SDUs at re-establishment of lower layers for radio bearers mapped on RLC AM, cipher and decipher control plane data, perform integrity protection and integrity verification of control plane data, control timer-based discard of data, and perform security operations (e.g., ciphering, deciphering, integrity protection, integrity verification, etc.).

The main services and functions of the RRC layer 1805 may include broadcast of system information (e.g., included in Master Information Blocks (MIBs) or System Information Blocks (SIBs) related to the non-access stratum (NAS)), broadcast of system information related to the access stratum (AS), paging, establishment, maintenance and release of an RRC connection (e.g., RRC connection paging, RRC connection establishment, RRC connection modification, and RRC connection release), establishment, configuration, maintenance and release of point to point Radio Bearers, security functions including key management, inter radio access technology (RAT) mobility, and measurement configuration for UE measurement reporting. MIBs and SIBs may comprise one or more information elements (IEs), which may each comprise individual data fields or data structures.

The UE and the RAN node may utilize a Uu interface (e.g., an NR interface) to exchange control plane data via a protocol stack comprising the PHY layer 1801, the MAC layer 1802, the RLC layer 1803, the PDCP layer 1804, and the RRC layer 1805.

The non-access stratum (NAS) protocols 1806 form the highest stratum of the control plane between the UE and the Core Network (CN). The NAS protocols 1806 may support the mobility of the UE and the session management procedures to establish and maintain IP connectivity between the UE and the network.

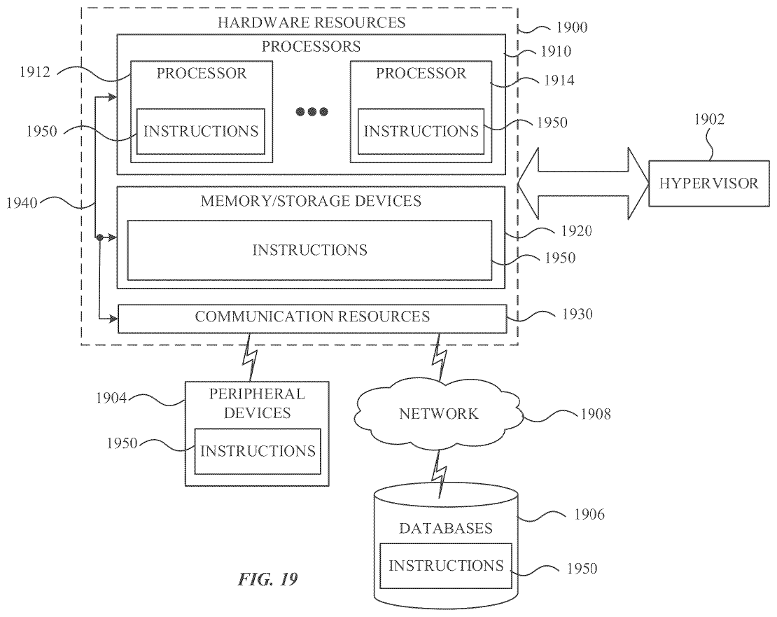

FIG. 19 is a block diagram illustrating components, according to some example implementations, able to read instructions from a machine-readable or computer-readable medium (e.g., a non-transitory machine-readable storage medium) and perform any one or more of the methodologies discussed herein. Specifically, FIG. 19 shows a diagrammatic representation of hardware resources 1900 including one or more processors (or processor cores) 1910, one or more memory/storage devices 1920, and one or more communication resources 1930, each of which may be communicatively coupled via a bus 1940. For implementations where node virtualization (e.g., NFV) is utilized, a hypervisor 1902 may be executed to provide an execution environment for one or more network slices/sub-slices to utilize the hardware resources 1900

The processors 1910 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) may include, for example, a processor 1912 and a processor 1914.

The memory/storage devices 1920 may include main memory, disk storage, or any suitable combination thereof. The memory/storage devices 1920 may include, but are not limited to any type of volatile or non-volatile memory such as dynamic random-access memory (DRAM), static random-access memory (SRAM), erasable programmable read-only memory (EPROM), electrically erasable programmable read-only memory (EEPROM), Flash memory, solid-state storage, etc.

The communication resources 1930 may include interconnection or network interface components or other suitable devices to communicate with one or more peripheral devices 1904 or one or more databases 1906 via a network 1908. For example, the communication resources 1930 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 1950 may comprise software, a program, an application, an applet, an app, or other executable code for causing at least any of the processors 1910 to perform any one or more of the methodologies discussed herein. The instructions 1950 may reside, completely or partially, within at least one of the processors 1910 (e.g., within the processor's cache memory), the memory/storage devices 1920, or any suitable combination thereof. Furthermore, any portion of the instructions 1950 may be transferred to the hardware resources 1900 from any combination of the peripheral devices 1904 or the databases 1906. Accordingly, the memory of processors 1910, the memory/storage devices 1920, the peripheral devices 1904, and the databases 1906 are examples of computer-readable and machine-readable media.

Examples herein can include subject matter such as a method, means for performing acts or blocks of the method, at least one machine-readable medium including executable instructions that, when performed by a machine (e.g., a processor (e.g., processor, etc.) with memory, an application-specific integrated circuit (ASIC), a field programmable gate array (FPGA), or the like) cause the machine to perform acts of the method or of an apparatus or system for concurrent communication using multiple communication technologies according to implementations and examples described.

In example 1, which may also include one or more of the example described herein, a baseband processor of a user equipment (UE) may comprise: one or more processors configured to: communicate a media access control (MAC) control element (CE) to another UE via a sidelink (SL) transmission, the MAC CE including an inter-UE coordination (IUC) information message indicating at least one wireless resource, associated with a time-domain validity, that the other UE is permitted to use to communicate with the UE.

In example 2, which may also include one or more of the example described herein, the IUC information message is sent in response to reception of a MAC CE IUC request message from the other UE. In example 3, which may also include one or more of the example described herein, the time-domain validity comprises an indication of a one-time resource by not including a periodicity of the wireless resources. In example 4, which may also include one or more of the example described herein, the time-domain validity comprises a duration of time for which the at least one wireless resource is valid for communicating with the UE.

In example 5, which may also include one or more of the example described herein, the time-domain validity comprises a plurality of validity windows, each validity window of the plurality of validity windows comprising a duration of time for which the at least one wireless resource is valid for communicating with the UE. In example 6, which may also include one or more of the example described herein, the at least one wireless resource comprises a plurality of wireless resources, each wireless resource of the a plurality of wireless resources having a different periodicity and a same time-domain validity. In example 6, which may also include one or more of the example described herein, the at least one wireless resource comprises a plurality of wireless resources, each wireless resource of the a plurality of wireless resources having a different periodicity and being associated with a different time-domain validity.

In example 8, which may also include one or more of the example described herein, the time-domain validity corresponds to a request for the time-domain duration indicated in a IUC request message from the other UE. In example 9, which may also include one or more of the example described herein, the time-domain validity is configured by a base station in communication with the UE. In example 10, which may also include one or more of the example described herein, time-domain validity is configured by another UE via PC5radio resource control (RRC) signaling. In example 11, which may also include one or more of the example described herein, the at least one wireless resources comprise a plurality of wireless resources included in the MAC CE, each wireless resource of the plurality of wireless resources having a different periodicity.

In example 12, which may also include one or more of the example described herein, the at least one wireless resources comprises a plurality of wireless resources included in different MAC CEs. In example 13, which may also include one or more of the example described herein, the IUC information message is communicated to the other UE within a latency bound during which the other UE is configured to receive the IUC information message, the latency bound comprising a time requirement to respond to an IUC request message that comprises a resource selection window from the other UE. In example 14, which may also include one or more of the example described herein, the latency bound is determined with the configured time value in Uu RRC by a base station or PC5-RRC by the other UE.

In example 15, which may also include one or more of the example described herein, the latency bound is determined by comparing the configured time value with the resource selection window. In example 16, which may also include one or more of the example described herein, the latency bound comprises a processing gap corresponding to a duration of time for the other UE to process the IUC information message. In example 17, which may also include one or more of the example described herein, the processing gap is configured by the base station. In example 18, which may also include one or more of the example described herein, the latency bound comprises an extended discontinuous reception (DRX) active time of the other UE.

In example 19, which may also include one or more of the example described herein, the at least one wireless resource is selected, and the MAC CE is communicated, based on an active DRX time of the other UE. In example 20, which may also include one or more of the example described herein, the MAC CE is communicated based on a side link (SL) grant from a base station.

In example 21, which may also include one or more of the example described herein, a user equipment (UE) may comprise: a memory device comprising instruction; and one or more processors that when executing the instructions cause the one or more processors to: communicate a media access control (MAC) control element (CE) to another UE via a sidelink (SL) transmission, the MAC CE including an inter-UE coordination (IUC) information message indicating at least one wireless resource, associated with a time-domain validity, that the other UE is permitted to use to communicate with the UE. In example 22, which may also include one or more of the example described herein, a method performed by a user equipment (UE) may comprise: communicating a media access control (MAC) control element (CE) to another UE via a sidelink (SL) transmission, the MAC CE including an inter-UE coordination (IUC) information message indicating at least one wireless resource, associated with a time-domain validity, that the other UE is permitted to use to communicate with the UE.

The above description of illustrated examples, implementations, aspects, etc., of the subject disclosure, including what is described in the Abstract, is not intended to be exhaustive or to limit the disclosed aspects to the precise forms disclosed. While specific examples, implementations, aspects, etc., are described herein for illustrative purposes, various modifications are possible that are considered within the scope of such examples, implementations, aspects, etc., as those skilled in the relevant art can recognize.

In this regard, while the disclosed subject matter has been described in connection with various examples, implementations, aspects, etc., and corresponding Figures, where applicable, it is to be understood that other similar aspects can be used or modifications and additions can be made to the disclosed subject matter for performing the same, similar, alternative, or substitute function of the subject matter without deviating therefrom. Therefore, the disclosed subject matter should not be limited to any single example, implementation, or aspect described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature may have been disclosed with respect to only one of several implementations, such feature may be combined with one or more other features of the other implementations as may be desired and advantageous for any given or particular application.

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description and the claims, such terms are intended to be inclusive in a manner similar to the term “comprising.” Additionally, in situations wherein one or more numbered items are discussed (e.g., a “first X”, a “second X”, etc.), in general the one or more numbered items can be distinct, or they can be the same, although in some situations the context may indicate that they are distinct or that they are the same.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. A baseband processor, comprising:
one or more processors configured to:
communicate a media access control (MAC) control element (CE) from a user equipment (UE) to another UE via a sidelink (SL) transmission,
the MAC CE including an inter-UE coordination (IUC) information message indicating at least one wireless resource, associated with a time-domain validity, that the other UE is permitted to use to communicate with the UE.

2. The baseband processor of claim 1, wherein the IUC information message is sent in response to reception of a MAC CE IUC request message from the other UE.

3. The baseband processor of claim 1, wherein the time-domain validity comprises an indication of a one-time resource by not including a periodicity of the at least one wireless resource.

4. The baseband processor of claim 1, wherein the time-domain validity comprises a duration of time for which the at least one wireless resource is valid for communicating with the UE.

5. The baseband processor of claim 1, wherein the time-domain validity comprises a plurality of validity windows, each validity window of the plurality of validity windows comprising a duration of time for which the at least one wireless resource is valid for communicating with the UE.

6. The baseband processor of claim 1, wherein:
the at least one wireless resource comprises a plurality of wireless resources, each wireless resource of the a plurality of wireless resources having a different periodicity and a same time-domain validity.

7. The baseband processor of claim 1, wherein the at least one wireless resource comprises a plurality of wireless resources, each wireless resource of the plurality of wireless resources having a different periodicity and being associated with a different time-domain validity.

8. The baseband processor of claim 1, wherein the time-domain validity corresponds to a request for a time-domain duration indicated in a IUC request message from the other UE.

9. The baseband processor of claim 1, wherein the time-domain validity is configured by a base station in communication with the UE.

10. The baseband processor of claim 1, wherein the time-domain validity is configured by another UE via PC5_radio resource control (RRC) signaling.

11. The baseband processor of claim 1, wherein:
the at least one wireless resource comprise a plurality of wireless resources included in the MAC CE, each wireless resource of the plurality of wireless resources having a different periodicity.

12. (canceled)

13. The baseband processor of claim 1, wherein the IUC information message is communicated to the other UE within a latency bound during which the other UE is configured to receive the IUC information message, the latency bound comprising a time requirement to respond to an IUC request message that comprises a resource selection window from the other UE.

14. The baseband processor of claim 13, wherein the latency bound is determined with a time value configured in Uu RRC by a base station or PC5-RRC by the other UE.

15. The baseband processor of claim 14, wherein the latency bound is determined by comparing the time value with the resource selection window.

16. The baseband processor of claim 13, wherein the latency bound comprises a processing gap corresponding to a duration of time for the other UE to process the IUC information message, wherein the processing gap is configured by a base station.

17. (canceled)

18. The baseband processor of claim 13, wherein the latency bound comprises an extended discontinuous reception (DRX) active time of the other UE.

19. The baseband processor of claim 1, wherein:
the at least one wireless resource is selected, and the MAC CE is communicated, based on an active DRX time of the other UE.

20. The baseband processor of claim 1, wherein the MAC CE is communicated based on a side link (SL) grant from a base station.

21. A user equipment (UE), comprising:
a memory device storing instructions; and
one or more processors that when executing the instructions cause the one or more processors to:
communicate a media access control (MAC) control element (CE) to another UE via a sidelink (SL) transmission,
the MAC CE including an inter-UE coordination (IUC) information message indicating at least one wireless resource, associated with a time-domain validity, that the other UE is permitted to use to communicate with the UE.

22-23. (canceled)

24. A method performed by a user equipment (UE), the method comprising:
communicating a media access control (MAC) control element (CE) to another UE via a sidelink (SL) transmission, the MAC CE including an inter-UE coordination (IUC) information message indicating at least one wireless resource, associated with a time-domain validity, that the other UE is permitted to use to communicate with the UE.

25-26. (canceled)
